(19) United States
(12) Patent Application Publication
(10) Pub. No.: US 2006/0038099 A1
(43) Pub. Date: Feb. 23, 2006

(54) Automotive clip with recessed notch to facilitate correct placement of a wiring harness trough and cover

(76) Inventor: Raymond Kalinowski, Washington Township, MI (US)

Correspondence Address: GIFFORD, KRASS, GROH, SPRINKLE & CITKOWSKI, P.C, PO BOX 7021, TROY, MI, 48007-7021, US

(21) Appl. No.: 10/921,558

(22) Filed: Aug. 19, 2004

(51) Int. Cl. F16L 3/08

(52) U.S. Cl. 248/231.81

(57) ABSTRACT

A clip for use with a wire harness trough, the trough including apertured brackets alignable with sheet metal studs extending from a vehicle interior. The clip includes first and second biasing portions adapted to mount to a selected bracket, and such that the portions engage against opposite faces of the bracket. Inwardly directed edges associated with the biasing portions define a through aperture, positioned in alignment with the selected bracket aperture and sized for receiving, in inserting fashion therethrough, a selected sheet metal stud. A marking indicia is associated with the clip for specifying application to a mounting stud of a given size and includes such as a notch defined at a given location on one of the biasing portions, or a colorization scheme associated with the clip.

### BACKGROUND OF THE INVENTION

1. Field of the Invention

The present invention relates generally to automotive clip designs. More specifically, the present invention discloses an automotive clip exhibiting a recessed notch, or other suitable and colorized arrangement, which facilitates correct placement with a correspondingly dimensioned mounting stud, in turn utilized for affixing a wiring harness trough and cover arrangement within a vehicle.

2. Description of the Prior Art

The prior art is well documented with varying examples of attachment clips and assemblies. In particular, such clip designs are useful in securing wiring harnesses and the like which extend within land, sea and air vehicles.

A first example of a clip for securing a wire harness to a vehicle panel is set forth in U.S. Pat. No. 5,615,851, issued to LeBeau. The clip includes a tower having a flange for embracing the harness and a hollow cylindrical member extending downwardly from the flange for insertion through an aperture in the harness. Retention legs extend through the cylindrical member and a lever base integral with the flange pivotally supports an operating lever. A piston is positioned slidably between the legs, and the legs and piston are connected to the lever via an eccentric mechanism.

In operation, the legs are inserted through an aperture in the vehicle panel and the operating lever is pivoted. The eccentric mechanism drives the piston downwardly relative to the legs to separate the legs and cause them to move outwardly into engagement with the aperture in the vehicle panel. Simultaneously, the legs are moved axially in a shortening direction to bring head structures on the free ends of the legs in contact with the remote face of the vehicle panel, whereafter the lever is latched to the lever base.

U.S. Pat. No. 4,871,134, issued to Oikawa, teaches a clip for securing a wiring harness in position and has a holder portion for holding the wiring harness and a flange portion extending transversely from the holder potion for securing the clip to a fixed part of the vehicle structure. The flange is pivotally connected to the holder portion so that the former, in assembly, can be collapsed in parallel to the later from the normally erect position, reducing the overall dimension of the combined clip and harness to facilitate insertion of the combination through a panel hole of relatively smaller dimension.

U.S. Pat. No. 5,694,678, issued to Karasik, teaches a wire harness retainer clip holding system employing a family of retainer clips. Each of the clips are adjustable to properly position a retainer clip at a desired location on a wire harness. Each of the clips includes a retainer clip holding portion, a frame for mounting the retainer clip holder portion at a desired location, a base for mounting the frame on a jig for assembly of a wire harness, the frame further incorporating circuitry to provide a signal indicating the presence of a retainer clip in the retainer clip holding portion. First, second and third holding portions associated with the retainer clip are adjustable along x, y and z axes, respectively, in order to adjust their orientation and support an extending wire harness.

U.S. Pat. No. 5,962,814, issued to Skipworth et al., teaches a wire harness trough with pivoting (hinged) guide for controlling movement of the wire harness adjacent the protector trough. The protector is an open-ended trough with a hinged, latchable cover and fasteners for securing the trough to a moving surface, such as a vehicle trunk lid. The guide is hinged to an end of the trough, with a free end enabling it to swing relative to the trough. A central slot extends along a length of the guide, sized to receive a standard clip head strapped to the wire harness in a fixed position on the harness. When the surface to which the trough is secured moves, the wire harness slides relative to the trough. The clip head travels along the slot and the guide pivots relative to the end of the trough, controlling both sliding and bending movement of the wire harness.

U.S. Pat. No. 6,683,257, issued to Roberts et al., teaches an attachment clip including an inner body portion and an outer body portion separated by a cavity, and a secondary spreader located between the cavity and a bottom of an elongated cavity. The secondary spreader is located along an axis passing through the cavity and the elongated cavity to increase the flexibility of the inner and outer body portions. The attachment clip is integrally formed of the same material with a substrate by using an injection molding process, or other similar process, thereby eliminating the need for additional fasteners to attach the attachment clip to the substrate.

U.S. Pat. No. 6,206,331, issued to Keith et al., teaches a wire harness clip for securing a D-scrolled (cross-sectional) shaped wire harness to a panel type mounting surface, for example an automobile. A clip has an elongated mounting arm with an open-faced D-shape trough formed at one end and a panel-mounting clip such as a Christmas tree clip formed at an opposite end, on a common surface or side of the mounting arm. The trough includes a hinged cover adapted to releasably lock a D-scrolled wire harness into the trough.

Finally, U.S. Pat. No. 5,168,904, issued to Quinkert, teaches a reconfigurable jig for assembling a wire harness and including a number of fixture heads, each supportable in a variety of indexable positions and configurations by an adjustable post assembly which may be mounted in various configurations upon a perforated board.

### SUMMARY OF THE PRESENT INVENTION

The present invention discloses an automotive clip exhibiting a recessed notch, or other suitable and colorized arrangement, and which facilitates correct placement with a correspondingly dimensioned mounting stud, in turn utilized for affixing a wiring harness trough and cover arrangement within a vehicle. The clip is in use with a wire harness trough assembly, or other suitable component supporting structure, and such that it secures over an apertured bracket portion associated with the component and which is placed in alignment with a sheet metal stud extending from an interior vehicle location.

The clip includes first and second biasing portions adapted to mount to a selected bracket, such that the portions engage against opposite faces of the bracket. Inwardly directed edges associated with the biasing portions define a through aperture, positioned in alignment with the selected bracket aperture which is sized for receiving, in inserting fashion therethrough, a selected sheet metal stud.

A marking indicia is associated with said clip for specifying application to a mounting stud of a given size and may include such as a notch or incision defined at a given location. Alternately, or in addition, a colorization scheme may be employed with the clips to ensure that a correct clip design is employed for securing to a sheet metal stud of given diameter.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an environmental view of a wire harness trough and associated mounting bracketry securable over a vehicle sheet metal stud of a first dimension and with which is used an automotive clip according to a first preferred embodiment of the present invention;

FIG. 2 is a perspective view of the clip illustrated in the environmental arrangement of FIG. 1;

FIG. 3 is a top plan view of the clip of FIG. 2;

FIG. 4 is a side view of the clip of FIG. 2;

FIG. 5 is an end view of the clip of FIG. 2;

FIG. 6 is an environmental view of a wire harness trough and associated mounting bracketry securable over a vehicle sheet metal stud of a second dimension and with which is used an automotive clip according to a second preferred embodiment of the present invention;

FIG. 7 is a perspective view of the clip illustrated in the environmental arrangement of FIG. 6;

FIG. 8 is a top plan view of the clip of FIG. 6;

FIG. 9 is a side view of the clip of FIG. 6;

FIG. 10 is an end view of the clip of FIG. 6;

FIG. 11 is an environmental view of a wire harness trough and associated mounting bracketry securable over a vehicle sheet metal studs of a further diameter and with which is used a pair of automotive clips according to third and fourth preferred embodiments of the present invention;

FIG. 12 is a perspective view of a first of the clips illustrated in the environmental arrangement of FIG. 11;

FIG. 13 is a top plan view of the clip of FIG. 12;

FIG. 14 is a side view of the clip of FIG. 12;

FIG. 15 is an end view of the clip of FIG. 12;

FIG. 16 is a perspective view of a second of the clips illustrated in the environmental arrangement of FIG. 11;

FIG. 17 is a top plan view of the clip of FIG. 16;

FIG. 18 is a side view of the clip of FIG. 16;

FIG. 19 is an end view of the clip of FIG. 16;

FIG. 20 is an environmental view of a wire harness trough and associated mounting bracketry securable over a vehicle sheet metal stud of a yet further dimension and with which is used an automotive clip according to a further preferred embodiment of the present invention;

FIG. 21 is a perspective view of the clip illustrated in the environmental arrangement of FIG. 20;

FIG. 22 is a top plan view of the clip of FIG. 21;

FIG. 23 is a side view of the clip of FIG. 21;

FIG. 24 is an end view of the clip of FIG. 21; and

FIG. 25 is an environmental illustration of vehicle interior mounting application of a selected wire harness trough according to the present invention.

### DETAILED DESCRIPTION OF THE PREFERRED EMBODIMENTS

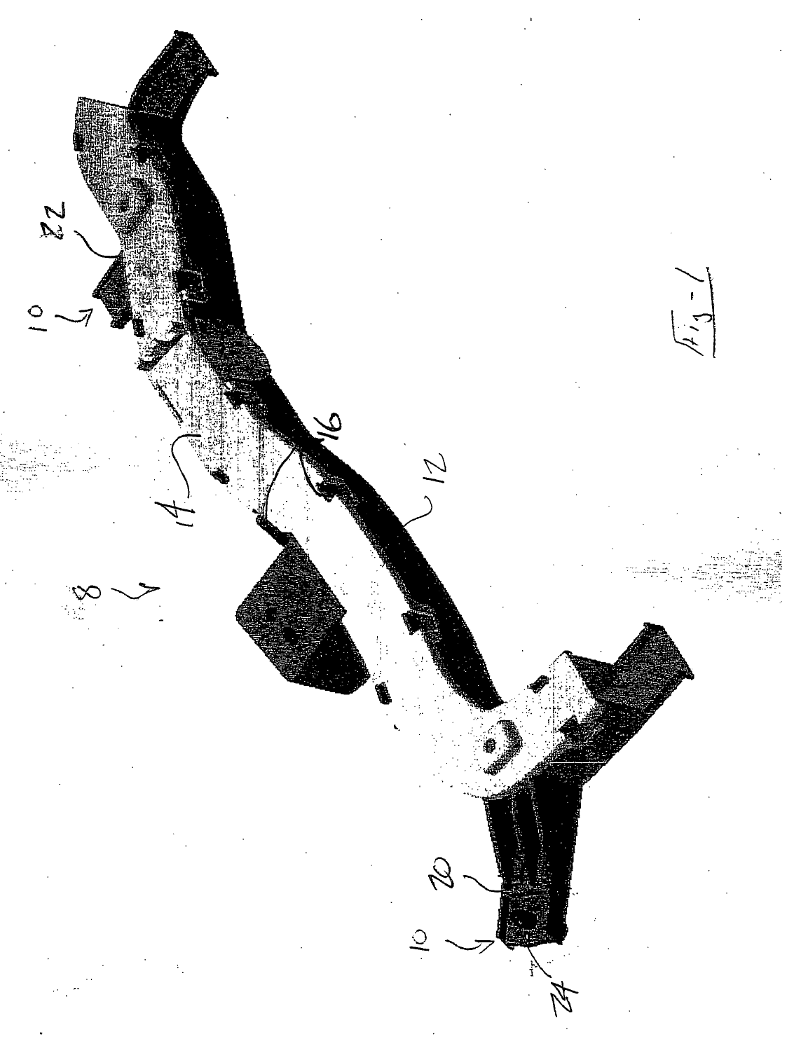

Referring to FIG. 1, an environmental illustration is shown at 8 of a wire harness trough and mounting bracketry according to a first preferred embodiment of the present invention. In particular a pair of clips 10, according to a first preferred embodiment, are illustrated and which are sized and configured to secure associated apertured bracket portions of the harness trough to sheet metal studs of a given diameter and which extend from given locations associated with a vehicle location.

As is also illustrated in FIG. 1, the trough typically holds a wire harness (not shown) and includes an elongated and three-dimensional body 12 and a lid 14 attached to the body 12 via a plurality of spaced apart tabs 16. As is also shown in the environmental view 18 of FIG. 25, a trough assembly can be secured in a suitable and extending location within a vehicle, such as which may include along a floor, a firewall, and the like.

Referring again to FIG. 1, brackets 20 and 22 are illustrated and which extend from locations along the body 12 of the wire harness trough. Although not clearly illustrated, it is understood that each of the brackets 20 and 22 exhibit (at a given location) an interior aperture which coincides with the location of installation of the clips 10. The number and arrangement of the brackets 20 and 22 are further such that they align with associated studs, such as illustrated at 24, which extend from the sheet metal interior of the vehicle and it is understood that their number and arrangement can be modified within the scope of the invention.

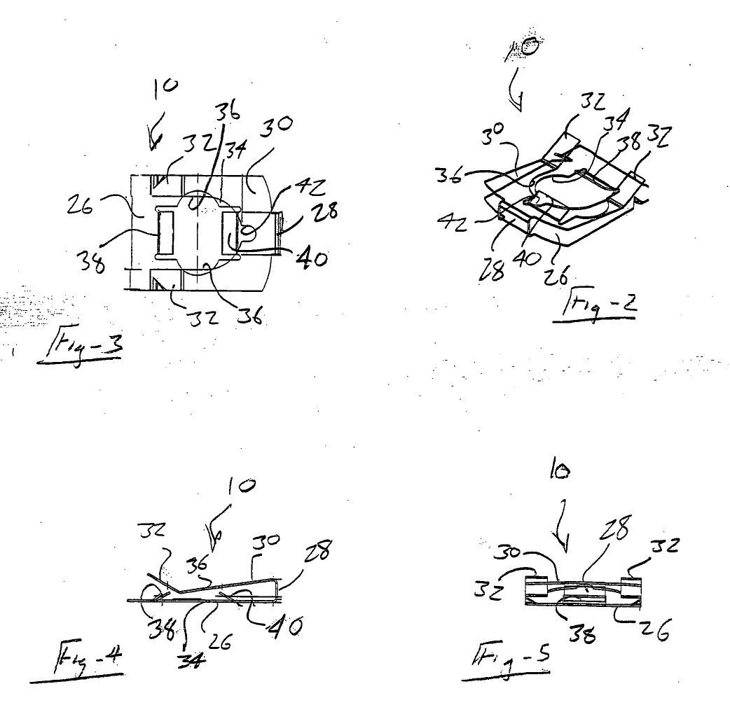

Referring also to FIGS. 2-5 in combination with FIG. 1, the clip 10 is illustrated in perspective and two-dimensional view and includes a body constructed of such as a spring steel material, i.e., in one embodiment an SAE 105-1065 rated steel and having a thickness typically (but without limitation) in a range of 0.25-0.50 mm. The clip includes a first biasing portion 26 and a second interconnected (see via stem portion 28) biasing portion 30 which is angled in opposing fashion relative to the first biasing portion 26 and which terminates in at least one angled end portion 32.

Each of the first and second biasing portions includes an interiorly defined aperture, and such as which is illustrated by inwardly directed edges 34 associated with biasing portion 26 and corresponding edges 36 associated with biasing portion 28. The apertures 34 and 36 are selected from round and elongated/slot shaped configurations, and can be shaped in other fashion without limitation.

In use, the clip 10 is slidably engaged over an edge of a flat planar area associated with the bracket (such as again at 20 or 22 in FIG. 1) and such that the biasing portions engage against opposite faces of the bracket. Each of the bracket mounting portions includes a central aperture, of suitable dimension for receiving a range of different diameter mounting studs, and which is positioned in alignment with the aperture extending through the trough assembly mounting bracket.

Referring again to FIGS. 2-5, angled tabs 38 and 40 are provided in extending fashion from the first biasing portion 26 and which engage against locations defined in the second biasing portion 30 (see spaced apart and arcuately extending arms) upon installation of the stud 24. In use, the clips 10 each define a first maximum insertion or engagement force (such at 10 lbs in one embodiment) for securing a stud 24 and which is usually (but not necessarily) less than a minimum extraction force (typically 25 lbs) required for removal of the clip from the stud.

A marking indicia is provided for associating the clip 10 with a given size mounting stud, and such as for example an 8 mm stud. In an embodiment, the marking indicia is provided as a notch or incision 42, such as for example semicircular shaped in configuration, and at a location along the semicircular shaped aperture defined in the arcuate arms defining the second biasing portion.

It is further envisioned that the location, size and configuration of the notch may be altered to designate the specifications of the clip for attaching to differently sized studs. Alternately, or additional, to the notching of the clips is the color coding of the clips to again designate application to a specifically configured stud. Along these lines, the clips can be coded red, blue or in any other scheme to designate application to a given dimension of stud. It is again noted that the apertures associated with the mounting brackets can exhibit a standard sized aperture, capable of receiving therethrough a range of different diameter studs, and which are fixedly secured by a specified clip installed upon the bracket.

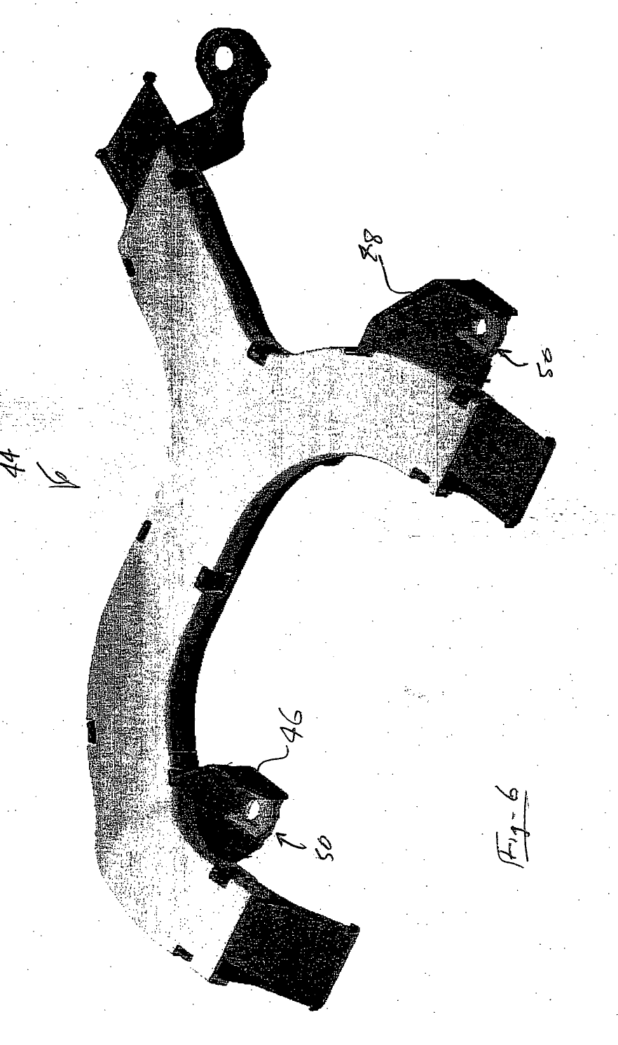

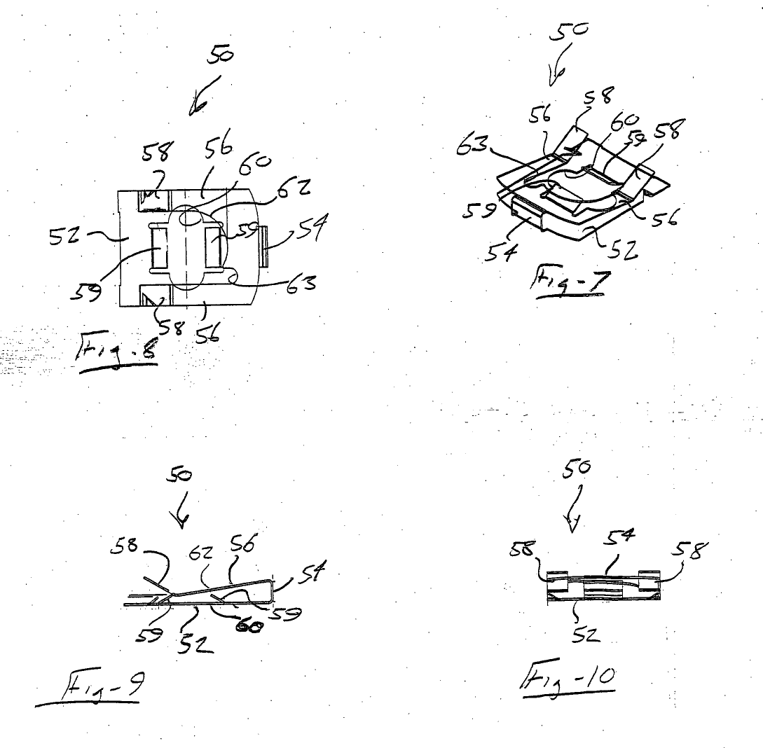

Illustrated generally at 44 in FIG. 6 is an environmental view of a wire harness trough of another design and associated mounting bracketry 46 and 48 securable over vehicle sheet metal studs (not illustrated in this view) of a second dimension and with which is used an automotive clip 50 according to another embodiment of the present invention. The clip 50 according to this embodiment, referencing also the views of FIGS. 7-10, is particularly designed to securing to an M6 sheet metal stud (i.e., one having a diameter in a range of 5.8-6.2 mm).

The clip 50 is largely similar in configuration with that illustrated at 10 in FIGS. 1-5 and includes a first biasing portion 52 and a second interconnected (see via stem portion 54) biasing portion 56 (in this instance again a pair of angled arms) which is angled in opposing fashion relative to the first biasing portion 52 and which terminates in angled end portions 58. Angled tabs are again shown at 59 to facilitate securing a designated sheet metal stud in place.

Each of the first and second biasing portions again includes an interiorly defined aperture, such as which is illustrated by inwardly directed edges 60 associated with biasing portion 52 and corresponding edges 62 associated with biasing portion 56. The apertures 60 and 62 are again selected from round and elongated/slot shaped configurations, and can be shaped in other fashions without limitation. As in the first disclosed embodiment, a semicircular notch 63 is defined in a selected arcuate extending location of the inwardly directed edge 62 of the second biasing portion in order to designate application of the clip to a given stud configuration.

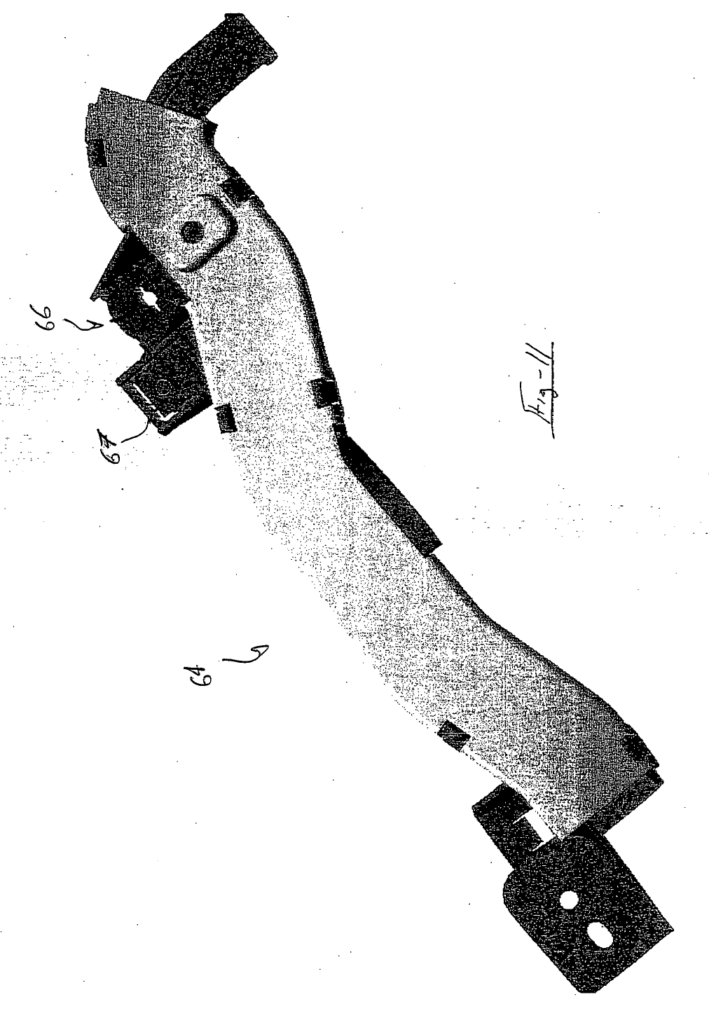

FIG. 11 is an environmental view of a wire harness trough and associated mounting bracketry 64 securable over a vehicle sheet metal studs of a further diameter and with which is used a pair of alternately configured automotive clips 66 and 67 according to third and fourth preferred embodiments of the present invention. In particular, the clips 66 and 68 can be used with a 5.00 mm diameter stud.

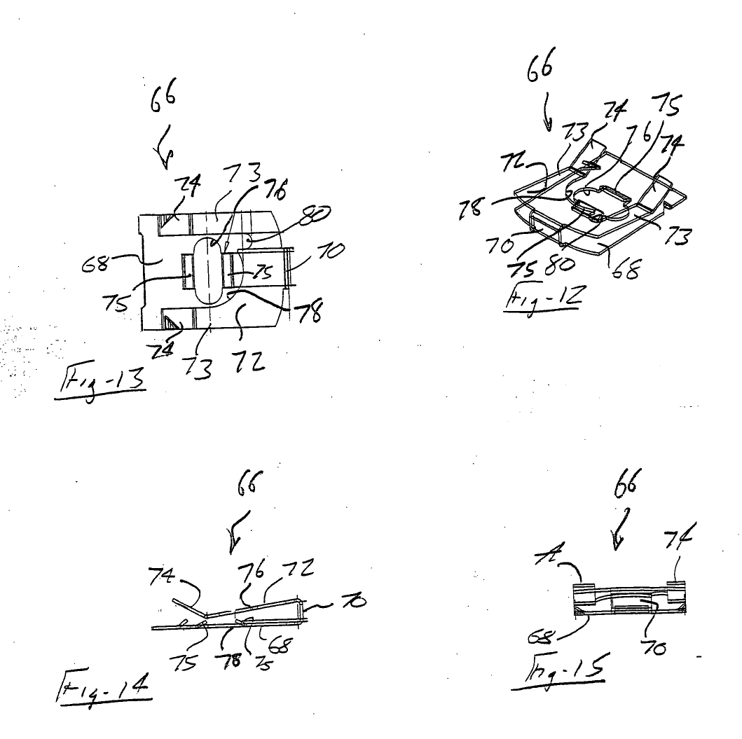

FIGS. 12-15 are perspective and varying two-dimensional views of a first of the clips 66 illustrated in the environmental arrangement of FIG. 11. The clip 66 is again similar in overall construction to the clips 10 and 50 of the previously described embodiments and once again includes a first biasing portion 68 and a second interconnected (see via stem portion 70) biasing portion 72 (in this instance again including a pair of projecting and angled arms 73) which is angled in opposing fashion relative to the first biasing portion 68 and which terminates in angled end portions 74. Angled tabs 75 are again illustrated and function as substantially described in the previous embodiments.

Each of the first and second biasing portions again includes an interiorly defined aperture, such as which is illustrated by inwardly directed edges 76 associated with biasing portion 68 and corresponding edges 78 associated with biasing portion 70. The apertures 76 and 78 are again selected from round and elongated/slot-shaped configurations, and can be shaped in other fashions without limitation. A notch 80 in the second biasing portion designates a rating of the clip 66 to a given diameter size of post.

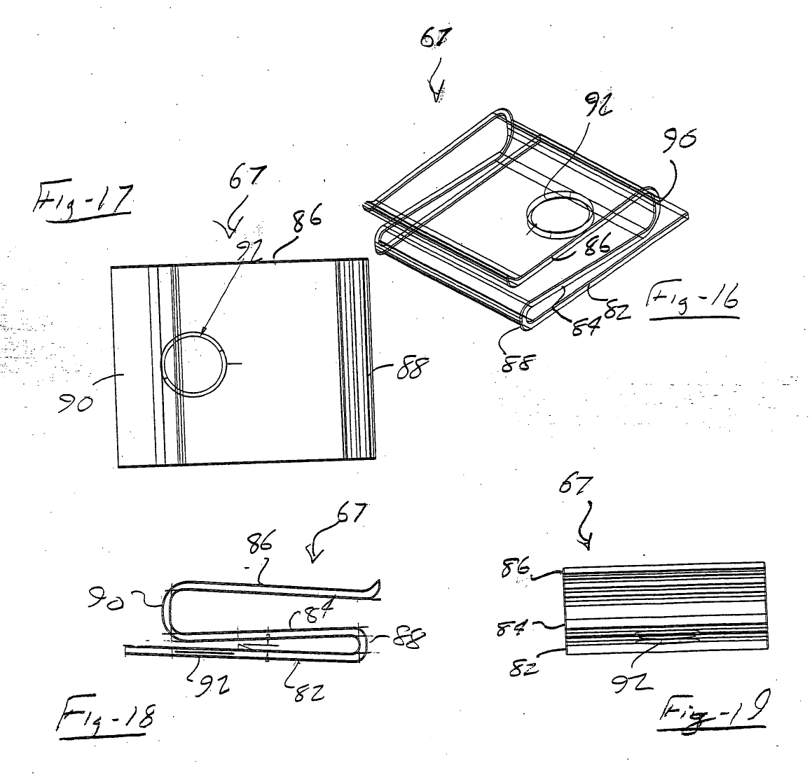

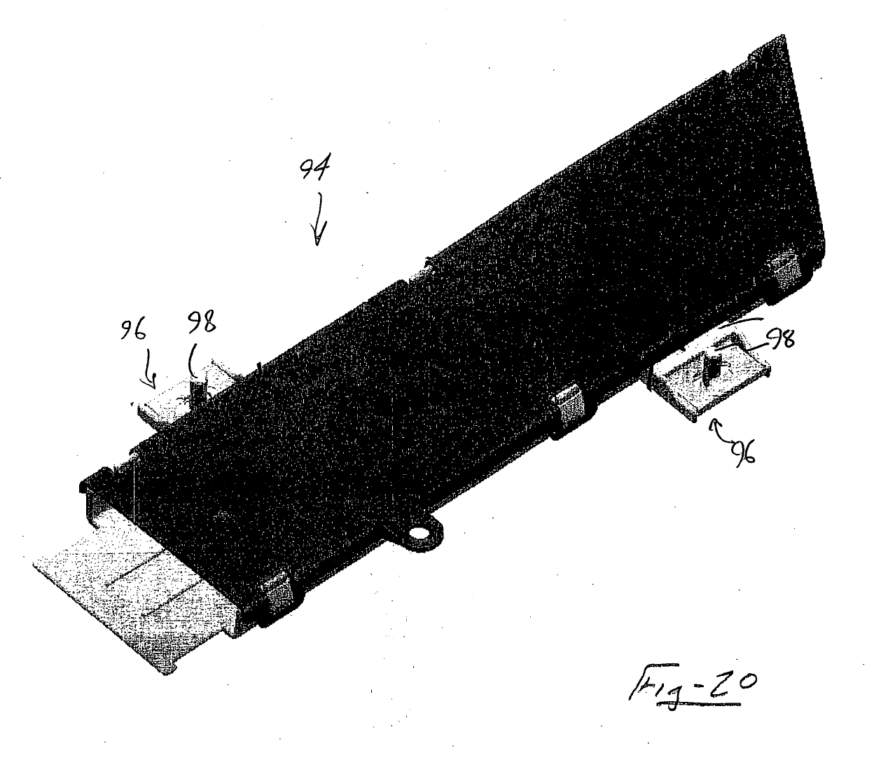

FIGS. 16-20 are perspective, top, side and end views of the second 67 of the clips illustrated in the environmental arrangement of FIG. 11. The clip 67 includes first 82, second 84 and third 86 successively reverse bent and angled portions. Angled end 88 interconnects first 82 and second 84 clip portions, whereas angled end 90 interconnects second 84 and third 86 clip portions.

The portions 82, 84 and 86 are each substantially planar shaped and define, collectively, a substantially “S” shape configuration and cross section. At least one aperture 92 is defined in one or both of the reverse bent portions 82 and 84 in order to secure a stud of given diameter. As with the earlier described embodiments, it is also envisioned that the clip can be color coded or notched in some manner to designate application to a given sized mounting stud.

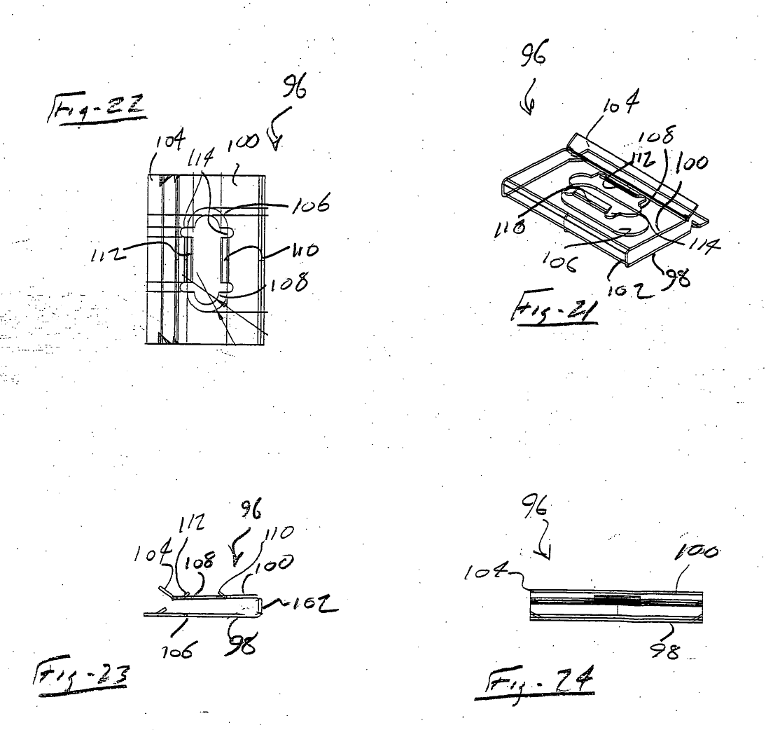

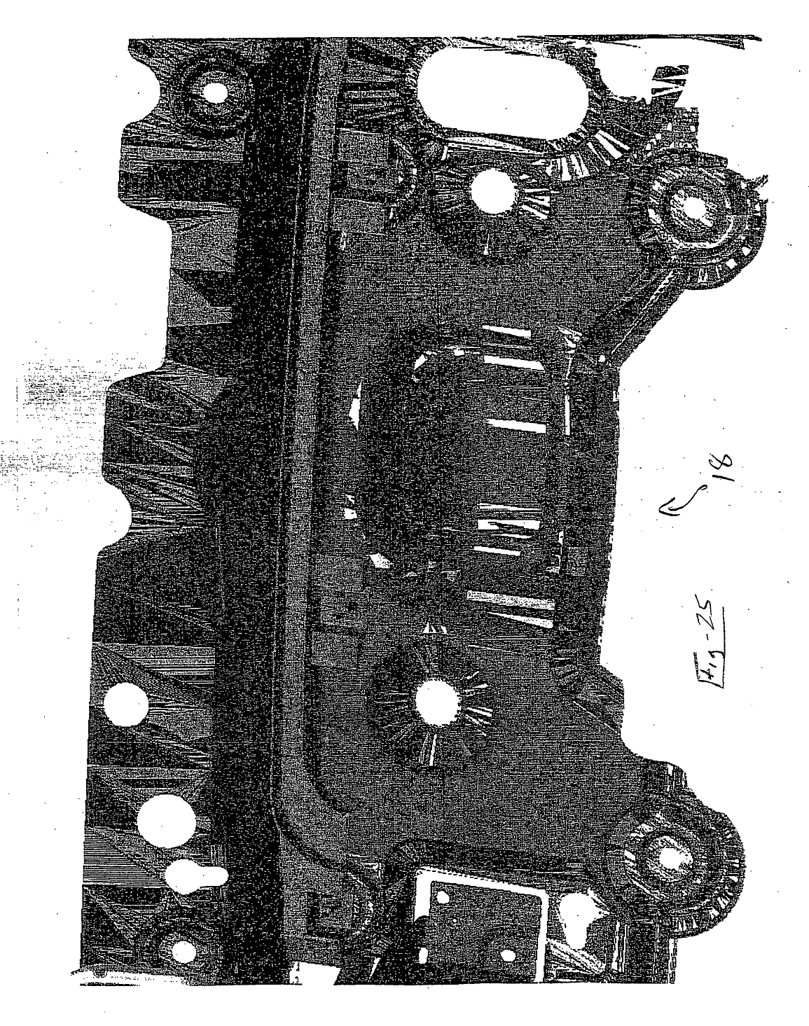

Referring now to FIG. 20 is an environmental view illustrated at 94 of a wire harness trough and associated mounting bracketry employing a clip 96 securable over vehicle sheet metal studs 98 of a yet further dimension according to another preferred embodiment of the present invention. As referenced by the perspective and two-dimensional views of FIGS. 21-24, the clip 96 includes first 98 and second 100 biasing portions (both substantially planar shaped) interconnected along a common edge 102 and such that the second biasing portion 100 extends in a substantially opposing manner relative to the first biasing portion 98. The second biasing portion 100 terminates in an angled end 104 to facilitate mounting of the clip 96 over an associated bracket portion of the trough assembly.

Again as with the previous embodiments, apertures (slot shaped in this instance) 106 and 108 are defined in the biasing portions 98 and 100 (see inwardly extending edges) and through which is inserted the sheet metal stud. Inwardly angled tabs 110 and 112 facilitate securing the studs in place and, in this instance, extend from an upper surface associated with the second biasing portion 100. Identifying notches are again provided at 114 and, along with color coding of the clip, serve to designate a size or rating of stud with which the clip can be used.

Having described my invention, other and additional preferred embodiments will become apparent to those skilled in the art to which it pertains, and without deviating from the scope of the appended claims.

I claim:

1. A clip for use with a wire harness trough, the trough including apertured brackets alignable with sheet metal studs extending from a vehicle interior, said clip comprising:
first and second biasing portions adapted to mount to a selected bracket, such that said portions engage against opposite faces of said bracket;
inwardly directed edges associated with said biasing portions defining a through aperture, positioned in alignment with the selected bracket aperture and sized for receiving, in inserting fashion therethrough, a selected sheet metal stud; and
a marking indicia associated with said clip for specifying application to a mounting stud of a given size.

2. The clip as described in claim 1, said first biasing portion further comprising a substantially planar shaped and centrally apertured portion, said second biasing portion further comprising at least one arcuately shaped and angled portion.

3. The clip as described in claim 2, said second biasing portion further comprising first and second spaced apart and arcuately extending arms.

4. The clip as described in claim 2, said second biasing portion further comprising a reverse angled end portion.

5. The clip as described in claim 2, said marking indicia further comprising a notch defined at a given location associated with said second biasing portion and visible from an associated facing side of the bracket.

6. The clip as described in claim 5, said notch further comprising an arcuate shaped incision defined in said arcuately shaped and angled portion.

7. The clip as described in claim 1, said marking indicia further comprising a colorization scheme associated with said clip.

8. The clip as described in claim 1, said second biasing portion releasably engaging said first biasing portion upon inserting application of the stud.

9. The clip as described in claim 8, said clip exhibiting a specified shape and size and further comprising a first insertion force for installing over a mounting stud and a second greater extraction force for removing from the mounting stud.

10. The clip as described in claim 1, said first biasing portion further comprising at least one angled tab engageable against said second biasing portion upon installation of the mounting stud.

11. The clip as described in claim 1, said first and second biasing portions further comprising substantially planar shaped and reverse bent portions.

12. The clip as described in claim 11, further comprising a third reverse bent portion extending from an edge of said second biasing portion and such that said clip exhibits an overall “S” shape in cross section.

13. The clip as described in claim 11, said clip exhibiting a specified shape and size, first and second aligning apertures corresponding to said biasing portion apertures each further comprising a substantially circular shape.

14. The clip as described in claim 11, said clip exhibiting a specified shape and size, first and second aligning apertures corresponding to said biasing portion apertures each further comprising a substantially elongated and slot shape.

15. A clip for use with a component supporting and apertured bracket secured to a sheet metal stud extending from a vehicle location, said clip comprising:
first and second reverse bent and biasing portions adapted to mount over a selected bracket and such that said portions engage against opposite faces of said bracket;
each of said biasing portions defining a through aperture positioned in alignment with the bracket aperture and sized for receiving, in inserting fashion therethrough, the stud; and
a marking indicia associated with said clip for specifying application to a mounting stud of a given size.

16. The clip as described in claim 15, said marking indicia further comprising at least one notch incision defined in at least one of said first and second biasing portions.

17. The clip as described in claim 15, said marking indicia further comprising a colorization scheme associated with said clip.

18. The clip as described in claim 15, said clip exhibiting a specified shape and size and being constructed of a spring steel material.

19. The clip as described in claim 15, said spring steel material associated with said clip further comprising a SAE 1050-1065 material and a thickness in a range of 0.25-0.50 mm.

20. The clip as described in claim 15, said second reverse bent portion further comprising first and second spaced apart and arcuately extending arms.
